(19) United States
(12) Patent Application Publication
(10) Pub. No.: US 2013/0192564 A1
(43) Pub. Date: Aug. 1, 2013

(54) LASER SHOCK PEENING APPLIED TO FUEL SYSTEM PUMP HEAD

(71) Applicants: Sanjay N. Thakur, Greenwood, IN (US); Jeffrey Cooper, Columbus, IN (US); Yong-Ching Chen, Columbus, IN (US)

(72) Inventors: Sanjay N. Thakur, Greenwood, IN (US); Jeffrey Cooper, Columbus, IN (US); Yong-Ching Chen, Columbus, IN (US)

(73) Assignee: CUMMINS INC., Columbus, IN (US)

(21) Appl. No.: 13/358,685

(22) Filed: Jan. 26, 2012

(51) Int. Cl. F02M 69/46; B23P 15/00

(52) U.S. Cl. 123/456; 29/888.02

(57) ABSTRACT

A fuel pump for pressurizing fuel and transporting the pressurized fuel to a common rail of an automotive engine is disclosed. The inner surface regions are processed by laser shock peening so that the fuel pump can provide a highly pressurized fuel to the common rail. The fuel pump includes an inlet check valve bore fluidly connected to a dome, the dome is fluidly connected to an outlet check valve bore, and the outlet check valve bore is fluidly connected to an outer check valve seat. A fuel-side surface of the fuel pump has a laser shock peened surface. The laser shock peened surface includes one or more of the fuel-side surface(s) of the inlet check valve bore, the dome, the outlet check valve bore, and/or the outlet check valve seat.

### TECHNICAL FIELD

The disclosed device is directed generally to an automotive engine component and a method for manufacturing the automotive engine component.

### BACKGROUND

A fuel pump for an automotive engine delivers fuel from a fuel tank to an engine cylinder. Some fuel pumps are configured to deliver fuel from the fuel tank to a common rail (also known as a distribution pipe). The fuel pump pressurizes the fuel during the transportation of the fuel from the fuel tank to deliver a highly pressurized fuel to the common rail. From the common rail, the pressurized fuel flows into multiple solenoid valves, then to one or more fuel injectors. The pressurized fuel is injected into a cylinder, where the pressurized fuel is further compressed to be exploded, thus generating kinetic energy required for driving the engine.

Laser shock peening (LSP) is a process of applying high intensity pulse laser to create a shock or stress wave on the surface of the material, resulting in yielding and plastic deformation, and thereby, creating high compressive residual stresses extending below the surface of the material. The laser pulses are focused and a coating of black tape or other material may be applied to a surface of the metal to absorb the energy of the laser. The coating is impacted by the laser generating a shock wave in the metal, causing a molecular compressive wave which creates high compressive residual stresses desirable for fatigue life enhancement of the component.

### BRIEF SUMMARY

An embodiment described is a fuel pump for transporting fuel to a common rail of an automotive engine. The embodiment includes inner surface regions that are processed by LSP to provide an increased pressurized fuel to the common rail. The embodiment of the fuel pump includes a cavity for fuel flow, wherein the cavity has an inlet check valve bore fluidly connected to a dome, the dome being fluidly connected to an outlet check valve bore, and the outlet check valve bore fluidly connected to an outer check valve seat. A fuel-side surface of the cavity has a laser shock peened surface. The laser shock peened surface includes one or more of the fuel-side surface of the inlet check valve bore, the dome, the outlet check valve bore, and/or the outlet check valve seat.

In an embodiment, the fuel pump has a fuel pump head. An embodiment of a fuel pump head is configured to be fluidly connected to a common rail for transporting pressurized fuel to the common rail. The fuel pump head includes a cavity for fuel flow, the cavity having a fuel-side surface, the fuel-side surface including a laser shock peened portion.

An embodiment of the fuel pump head has the cavity that includes an inlet check valve bore, the inlet check valve bore being fluidly connected to a dome, the dome being fluidly connected to an outlet check valve bore, and the outlet check valve bore fluidly connected to an outer check valve seat. The laser shock peened portion being the fuel-side surface of one or more of the inlet check valve bore, the dome, the outlet check valve bore, the outlet check valve seat, and/or any combination thereof.

In an embodiment, out of the four listed elements of the cavity, the laser shock peened portion is the fuel-side surface of only one of the inlet check valve bore, the dome, the outlet check valve bore, or the outlet check valve seat. Thus, the fuel-side surface of three of the listed elements is not laser shock peened.

In an embodiment, out of the four listed elements of the cavity, the laser shock peened portion is the fuel-side surface of only two of the inlet check valve bore, the dome, the outlet check valve bore, and/or the outlet check valve seat. Thus, the fuel-side surface of two of the listed elements is not laser shock peened.

In an embodiment, out of the four listed elements of the cavity, the laser shock peened portion is the fuel-side surface of only three of the inlet check valve bore, the dome, the outlet check valve bore, and/or the outlet check valve seat. Thus, the fuel-side surface of one of the listed elements is not laser shock peened.

In an embodiment, of the four listed elements of the cavity, the laser shock peened portion is the fuel-side surface of all four of the inlet check valve bore, the dome, the outlet check valve bore, or the outlet check valve seat.

One embodiment of a method for manufacturing a fuel pump head includes forging the fuel pump head, hardening and tempering the fuel pump head, shot blasting the fuel pump head, machining the fuel pump head, washing the fuel pump head, polishing the fuel pump head, and laser shock peening a portion of a fuel-side surface of the fuel pump head, wherein the fuel pump head includes an inlet check valve bore, the inlet check valve bore being fluidly connected to a dome; the dome being fluidly connected to an outlet check valve bore; and the outlet check valve bore being fluidly connected to an outlet check valve seat. The laser shock peening the portion includes laser shock peening the fuel-side surface of one or more of the inlet check valve bore, the dome, the outlet check valve bore, and/or the outlet check valve seat.

### BRIEF DESCRIPTION OF THE DRAWINGS

FIG. 1 is a schematic diagram of an embodiment of a fuel system according to the present disclosure.

FIG. 2 shows a cross-sectional view of an embodiment of a fuel pump head of a fuel pump according to the present disclosure.

FIG. 3 shows a flow diagram of a method for manufacturing the fuel pump head according to the present disclosure.

FIG. 4 is a normalized graph of three data sets from TABLES 1-3, showing the longitudinal residual stress distribution of a fuel pump head at a laser shock peened portion of the fuel pump head.

FIG. 5 shows a normalized peak width distribution of the residual stress data of the three data sets from TABLES 1-3.

FIG. 6 is a normalized graph of three comparative data sets from TABLES 4-6, showing the longitudinal residual stress distribution of a fuel pump head at a non-laser shock peened portion.

FIG. 7 shows a normalized peak width distribution of the comparative data sets from TABLES 4-6.

FIG. 8 shows another flow diagram of a method for manufacturing the fuel pump head according to the present disclosure.

### DETAILED DESCRIPTION OF THE DRAWINGS

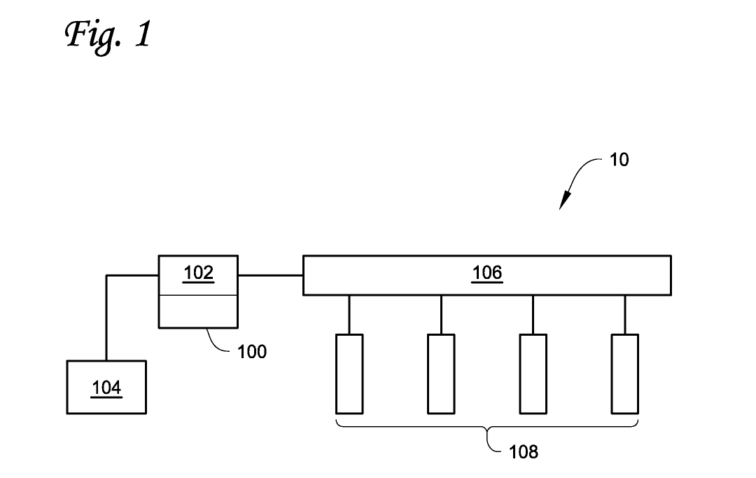

FIG. 1 shows a fuel system 10 including a fuel pump 100. The fuel pump 100 includes a fuel pump head 102 having a laser shock peened surface portion. The term laser shock peened portion means an area of a surface and a volume of material beneath the surface that has been hardened by LSP. The fuel pump 100 is fluidly connected to a fuel tank 104 and pumps the fuel from the fuel tank 104 to a common rail 106, which is fluidly connected to the fuel pump 100. The fuel pump 100 compresses the fuel arriving from the fuel tank 104, then the compressed fuel is delivered from the fuel pump 100 to the common rail 106. The compressed fuel is then delivered to the fuel injectors 108 for injecting the compressed fuel into pistons (not shown) of an engine.

Delivery of the compressed fuel to the common rail is needed for injecting highly compressed fuel by the injectors. The fuel pump 100 achieves higher thermal efficiency than a conventional fuel pump because higher compression of the fuel can be achieved due to LSP processed portion of the fuel pump head 102.

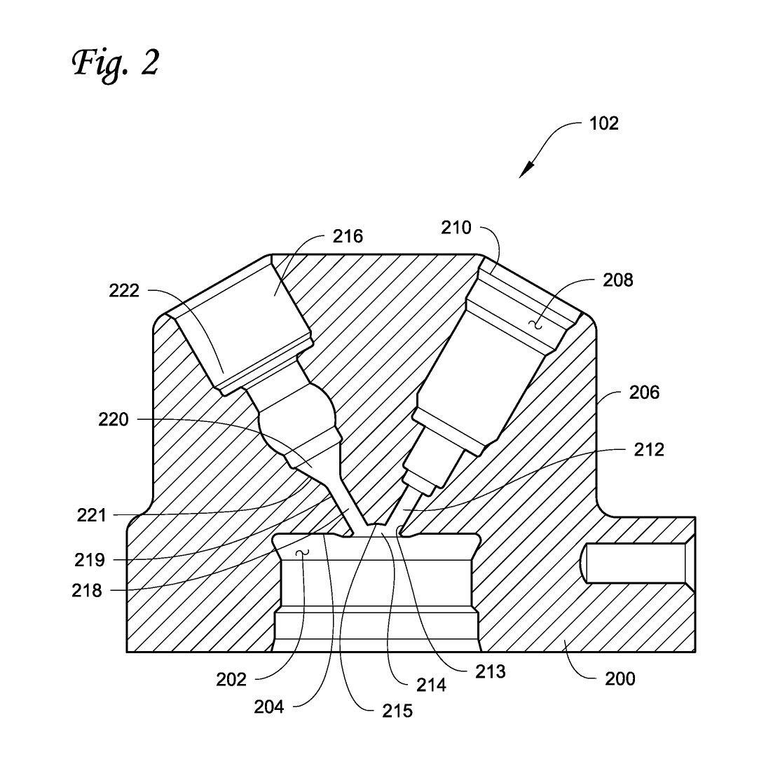

FIG. 2 shows an embodiment of the fuel pump 100 shown in FIG. 1. The fuel pump head 102 of the fuel pump 100 has a body 200. The body 200 of the fuel pump head 102 may be formed of a metal or an alloy. The fuel pump head 102 may be forged by a conventional forging process. An example of an alloy that can be used in forming the body 200 of the fuel pump head 102 can be, but is not limited to, steel. An example of an alloy that can be used in forming the body 200 of the fuel pump head 102 can be, but is not limited to, 4340 steel. Another example of an alloy that can be used in forming the body 200 of the fuel pump head 102 can be, but is not limited to, nitrided 4340 steel. The body 200 of the fuel pump head 102 has a cavity 202.

The inventor has determined that specific portion(s) of the cavity 202 of the fuel pump head 102 experience greater compressive stress than other portions of the cavity 202. The inventor has discovered that if the portion(s) can be made to withstand greater compressive stress, then the fuel can be compressed by the fuel pump 100 at a higher compression ratio. Higher operating fuel pressure can achieve higher thermal efficiency. Thus, the fuel pump head 102 can allow the fuel pump 100 to operate at higher operating pressures without the need to add other materials to form the fuel pump head 102. The higher operating pressures achieved by the fuel pump 100 can increase engine fuel efficiency due to better cylinder-to-cylinder fuel distribution due to better atomization of highly compressed fuel. Thus the fuel pump 100 can consume less fuel for equivalent power output than conventional fuel pumps. The highly compressed fuel from the fuel pump 100 can achieve an increased fuel bum rate and can lead to a reduced output of emissions.

The cavity 202 is at least partially filled with fuel when the fuel pump 100 is in operation. The cavity 202 has a fuel-side surface 204 that contacts the fuel during operation of the fuel pump 100. The body 200 has an outside surface 206 that does not contact the fuel during operation of the fuel pump 100. The fuel pump head 102 has an inlet 208 of the cavity 202 for flowing fuel into the cavity 202. The inlet 208 can include an inlet check valve thread and seal washer surface 210, and an inlet check valve bore 212. The cavity 202 has an outlet 216 for flowing pressurized fuel out from the cavity 202 of the fuel pump head 102 towards the common rail 106. The outlet 216 can include an outlet check valve bore 218, an outlet check valve seat 220, and an outlet check valve thread and seal washer surface 222. The cavity 202 has a dome 214 that is connected to both the inlet check valve bore 212 and the outlet check valve bore 218. The dome 214 receives the inflow of fuel from the inlet check valve bore. 212 and is in a path of pressurized fuel flow out to the outlet check valve bore 218.

The cavity 202 is configured to withstand compressive stress of the fuel as the fuel is compressed by the fuel pump 100. The fuel-side surface 204 of the cavity 202 has a specific portion(s) wherein the compressive stress due to pressurization of the fuel is greater than other regions of the fuel-side surface 204. The pressure can be from 2,000 bar to 2,600 bar. This pumping action of the pumping plunger is cyclic and can lead to fatigue failure in the portion(s). LSP processing of the portion(s) increases the compressive residual stress and enhances the fatigue life of the regions. The portion includes one or more of the inlet check valve bore 212, the dome 214, and a portion of an outlet 216 near the dome 214. The portion of the outlet 216 near the dome 214 include an outlet check valve bore 218 and an outlet check valve seat 220 of the outlet 216.

When the pumping plunger (not shown) comes up from the bottom of the fuel pump head 102 inside the cavity 202, the pumping plunger pressurizes the fuel near and towards the dome 214. The pressurization of the fuel causes compressive stress on the dome 214 and on a surface 215 of the dome 214. The pressurized fuel can also cause compressive stress on the inlet check valve bore 212 and on a surface 213 of the inlet check valve bore 212. The pressurized fuel can also cause compressive stress on the outlet check valve bore 218 and on a surface 219 of the outlet check valve bore 218. The pressurized fuel can also cause compressive stress on the outlet check valve seat 220 and on a surface 221 of the outlet check valve seat 220.

An embodiment of the fuel pump head 102 has a laser shock peened portion including the fuel-side surface 213 of the inlet check valve bore 212. An embodiment of the fuel pump head 102 has a laser shock peened portion including the fuel-side surface 215 of the dome 214. An embodiment of the fuel pump head 102 has a laser shock peened portion including the fuel-side surface 219 of the outlet check valve bore 218. An embodiment of the fuel pump head 102 has a laser shock peened portion including the fuel-side surface 221 of the outlet check valve seat 220. An embodiment of the fuel pump head 102 has a laser shock peened portion including one or more of the fuel-side surfaces 213, 215, 219, 221.

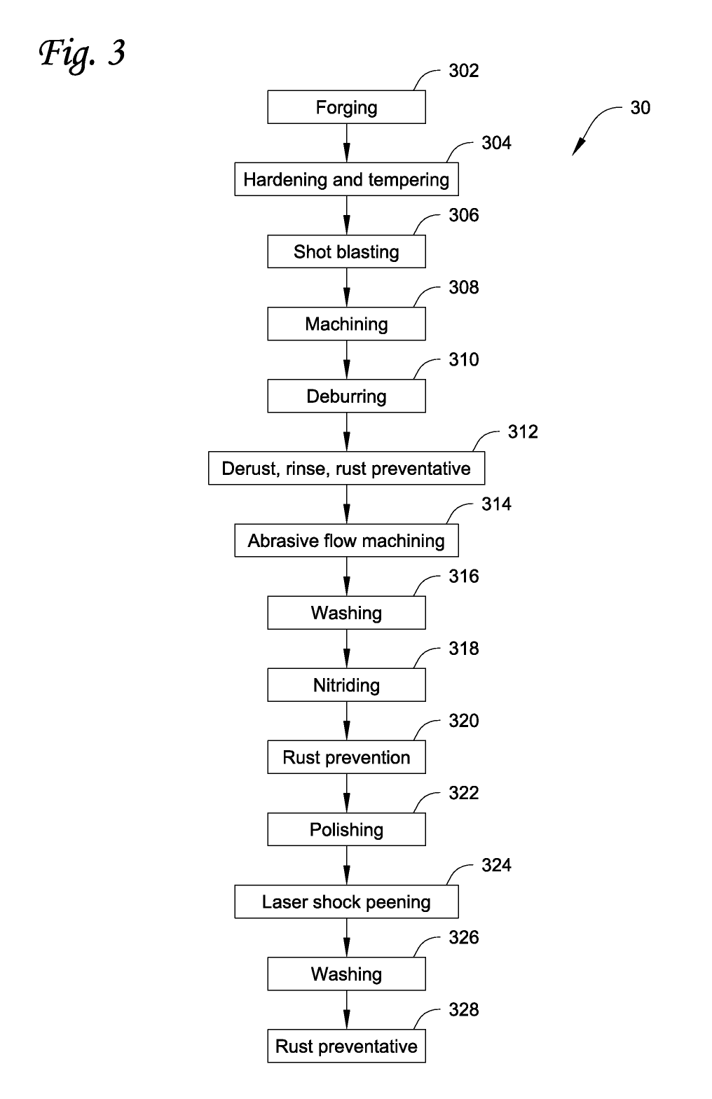

An embodiment of a flow diagram for a method 30 for manufacturing the fuel pump head 102 is shown in FIG. 3. Prior to performing LSP to portion(s) of the fuel pump head 102, the fuel pump head 102 can be formed using conventional methods that can include forging 302, hardening and tempering 304, shot blasting 306, machining 308, and deburring 310 steps. The deburring 310 may include hand deburring, washing, and then thermal deburring. The process can also include derusting, rinsing, and rust preventative step 312, abrasive flow machining 314, and washing 316. Washing 316 may include crystal clean washing, alkaline washing, and acetone washing. Nitriding 318 is a surface hardening heat treatment process that involves diffusion of nitrogen in the surface of metal while still in the ferrite region to create a case hardened surface. Nitriding 318 provides high surface hardness, which increases wear resistance and improves fatigue life of a component being nitrided. Because nitriding 318 does not involve heating into the austenite phase and subsequent quenching to form martensite, it can provide minimum distortion and excellent dimensional control.

The method can include rust prevention 320 step and a polishing 322 step. FIG. 3 shows the polishing step 322 being performed prior to the laser shock peening 324 step. Alternatively, the polishing step 322 can be performed after the laser shock peening 324 step.

Laser shock peening 324 is performed at one or more of the surfaces 213, 215, 219, 221 inside the cavity of the fuel pump head 102. Then, the fuel pump head 102 can be washed 326, and another rust preventative 328 step is performed to the fuel pump head 102. Thus, the fuel pump head 102 can be obtained via the embodied method above.

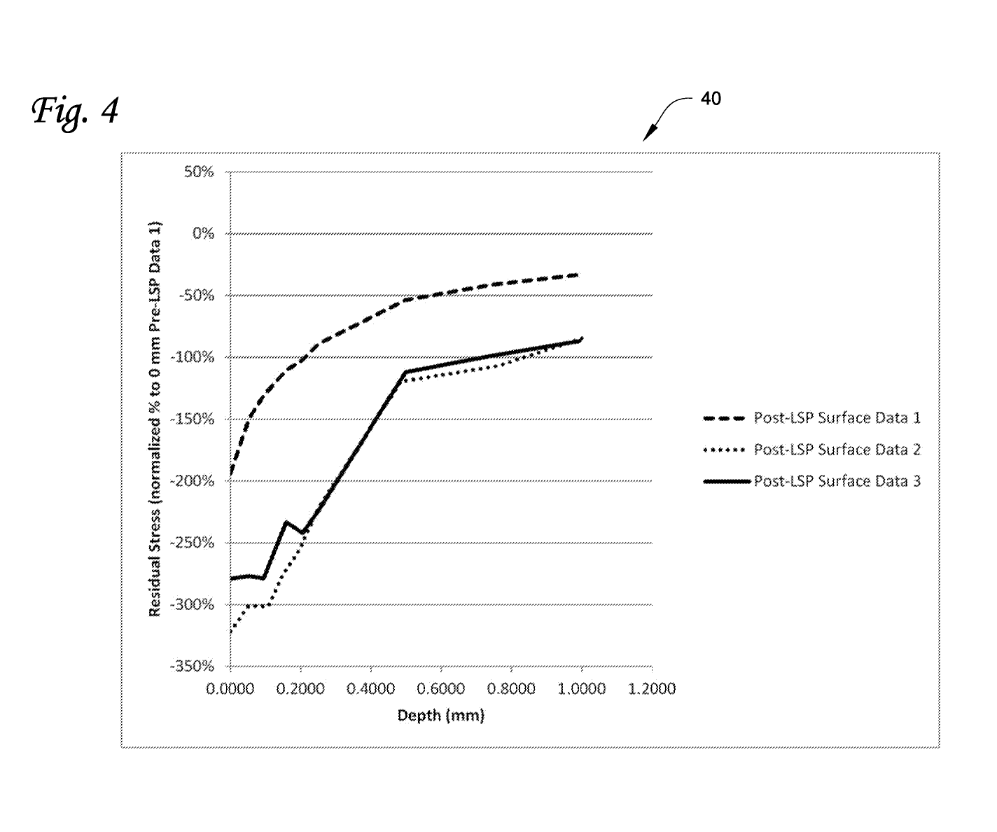

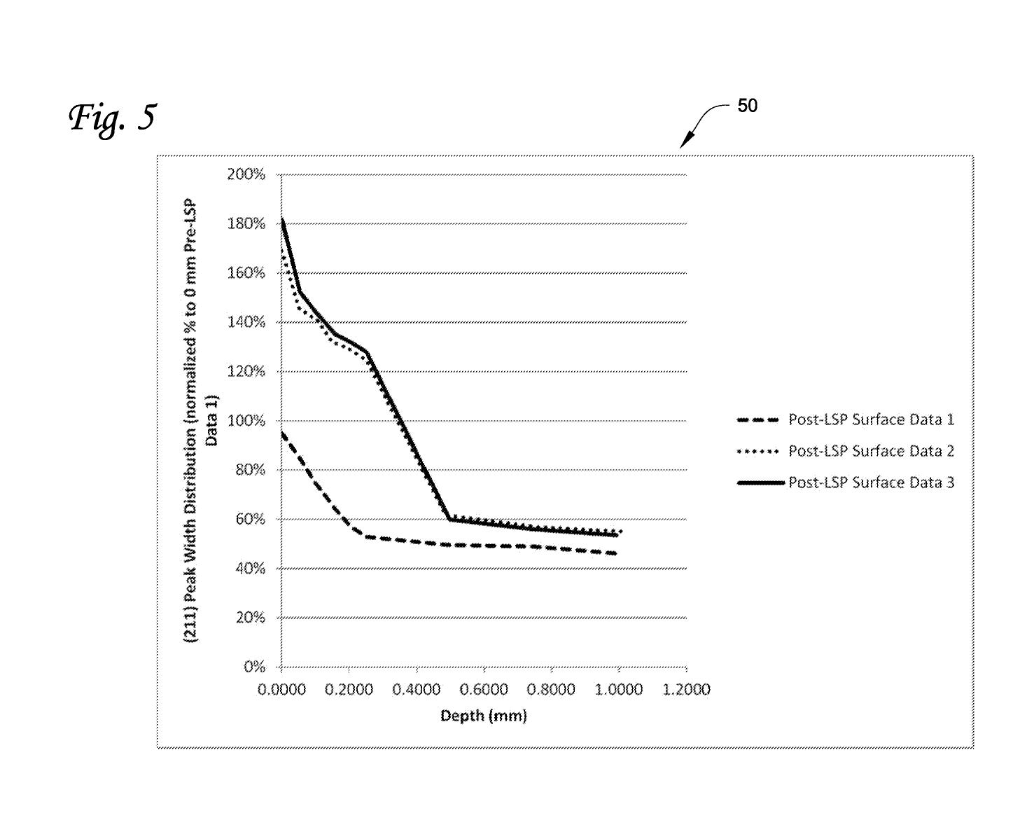

FIGS. 4 and 5 show graphs 40, 50 of experimental data showing the improved residual stress property of the LSP portion of the fuel pump head, e.g. fuel pump head 102. The data collected is labeled Post-LSP Data because the data has been gathered after the LSP process has been performed at a surface location of the fuel pump head.

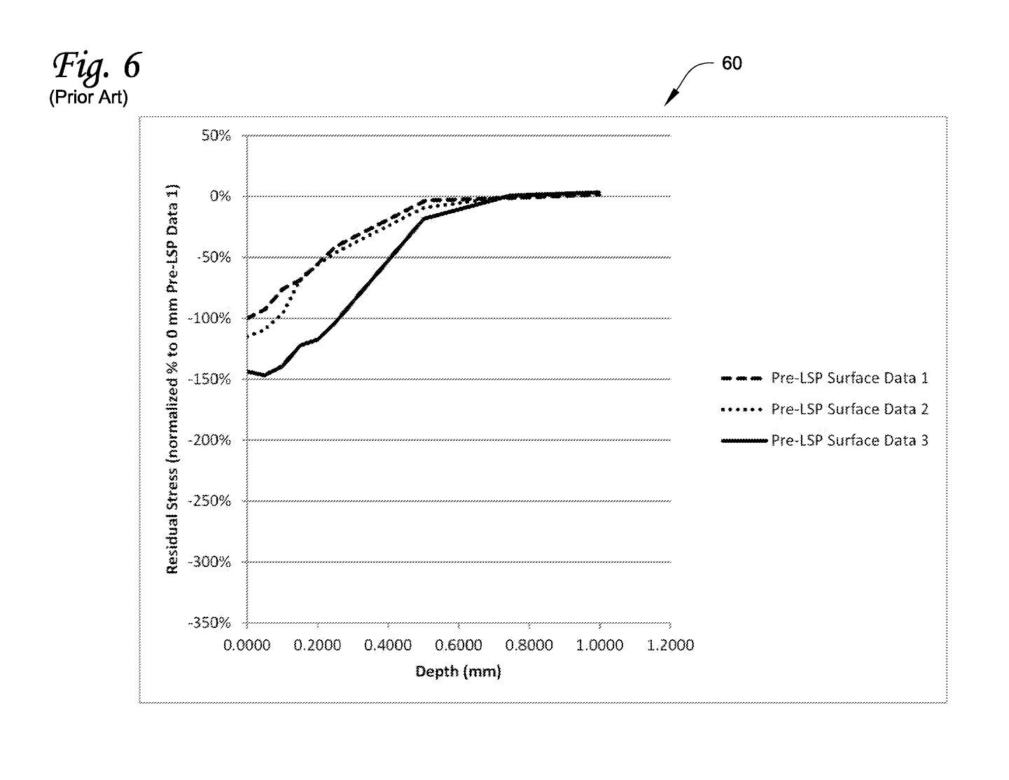

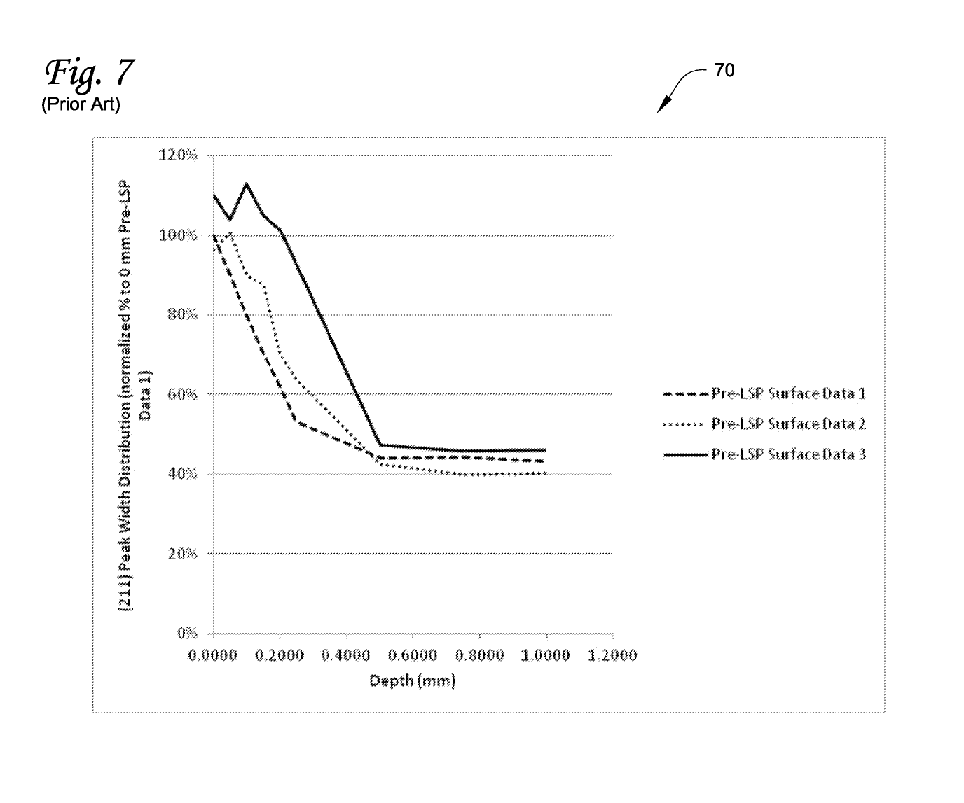

As a comparison, FIGS. 6 and 7 show graphs 60, 70 of residual stress distribution for a non-laser shock peened fuel pump head. Non-laser shock peened means Pre-LSP because the comparative data has been gathered before the LSP process has been performed at the same surface location of the fuel pump head as the surface location of the data collected for the Post-LSP data.

To determine the improved property of the fuel pump head, e.g. fuel pump head 102, the following X-ray diffraction residual stress measurement technique was employed to measure the residual stress of the laser shock peened portion of the surface of the fuel pump head 102. X-ray diffraction residual stress measurements were made at the surface and at nominal depths of 2.0×10⁻³, 3.9×10⁻³, 5.9×10⁻³, 7.9×10⁻³, 9.8×10⁻³, 19.7×10⁻³, 29.5×10⁻³, and 39.4×10⁻³ inches (50×10⁻³, 100×10⁻³, 150×10⁻³, 200×10⁻³, 250×10⁻³, 500×10⁻³, 750×10⁻³, and 1000×10⁻³ mm) X-ray diffraction residual stress measurements were performed using a two-angle sine-squared-psi technique in accordance with SAE HS-784, employing the diffraction of chromium

K-alpha radiation from the (211) planes of the body center cubic (BCC) structure of the nitrided 4340 steel. The diffraction peak angular positions at each of the psi tilts employed for measurement were determined from the position of the K-alpha 1 diffraction peak separated from the superimposed K-alpha doublet assuming a Pearson VII function diffraction peak profile in the high back-reflection region. The diffracted intensity, peak breadth, and position of the K-alpha 1 diffraction peak were determined by fitting the Pearson VII function peak profile by least squares regression after correction for the Lorentz polarization and absorption effects and for a linearly sloping background intensity. The diffractometer fixturing were as follows:

Incident Beam Divergence: 1.0 deg.

Detector: Scintillation set for 90% acceptance of chromium K-alpha energy

Psi rotation: 10.00 and 50.00 deg.

Irradiated Area: 0.20×0.20 in. (5.1×5.1 mm)

The value of the x-ray elastic constant, E/(1+v), required to calculate the macroscopic residual stress from the strain measured normal to the (211) planes of 4340 steel was determined empirically to be 24500±441 ksi.

The data obtained as a function of depth were corrected for the effects of the penetration of the radiation employed for residual stress measurement into the subsurface stress gradient. The stress gradient correction applied to the last depth measured is based upon an extrapolation to greater depths.

The stress values are shown in FIG. 4 such that, positive value for the “Residual Stress” axis means tensile stress, and negative value means compress stress. All Post-LSP data have been normalized to a percentile to Data No. 1 of Comparative Pre-LSP Data Set 1 (at 0.0000 mm depth) shown below in TABLE 4. FIG. 5 shows the (211) peak width distribution (B ½) values, also normalized to a percentile to Data No. 1 of Comparative Pre-LSP Data Set 1 shown below in TABLE 4. Normalized Data for Post-LSP Data Sets 1, 2, and 3 used for graphs 40, 50 are below (see TABLES 1, 2, and 3). The following table is the legend for FIGS. 4 and 5.

LEGEND FOR FIGS. 4 AND 5

| Mark | Data Set |
|---|---|
| [symbol] | Post-LSP Data Set 1 |
| ••••••• | Post-LSP Data Set 2 |
| [symbol] | Post-LSP Data Set 3 |

TABLE 1
Data Set 1
Post-LSP Surface - Normalized to Data No. 1
of Comparative Data Set 1

| Data | | | |
|---|---|---|---|
| No. | Depth (mm) | Residual Stress (normalized) | B ½ |
| 1 | 0.0000 | −194% | 95% |
| 2 | 0.0533 | −149% | 85% |
| 3 | 0.0940 | −131% | 76% |
| 4 | 0.1575 | −110% | 64% |
| 5 | 0.2057 | −102% | 57% |
| 6 | 0.2515 | −89% | 53% |
| 7 | 0.4978 | −54% | 50% |
| 8 | 0.7442 | −41% | 49% |
| 9 | 0.9931 | −33% | 46% |

TABLE 2
Data Set 2
Post-LSP Surface - Normalized to Data No. 1
of Comparative Data Set 1

| Data | | | |
|---|---|---|---|
| No. | Depth (mm) | Residual Stress (normalized) | B ½ |
| 1 | 0.0000 | −322% | 169% |
| 2 | 0.0508 | −301% | 146% |
| 3 | 0.1067 | −301% | 141% |
| 4 | 0.1473 | −276% | 132% |
| 5 | 0.1981 | −254% | 129% |
| 6 | 0.2515 | −221% | 124% |
| 7 | 0.4851 | −120% | 62% |
| 8 | 0.7595 | −107% | 57% |
| 9 | 1.0058 | −84% | 55% |

TABLE 3
Data Set 3
Post-LSP Surface - Normalized to Data No. 1
of Comparative Data Set 1

| Data | | | |
|---|---|---|---|
| No. | Depth (mm) | Residual Stress (normalized) | B ½ |
| 1 | 0.0000 | −279% | 182% |
| 2 | 0.0533 | −277% | 152% |
| 3 | 0.0940 | −279% | 145% |
| 4 | 0.1575 | −233% | 135% |
| 5 | 0.2057 | −242% | 132% |
| 6 | 0.2515 | −223% | 128% |
| 7 | 0.4978 | −112% | 60% |
| 8 | 0.7442 | −99% | 56% |
| 9 | 0.9931 | −87% | 54% |

The following table is the legend for FIGS. 6 and 7.

LEGEND FOR FIGS. 6 AND 7

| Mark | Data Set |
|---|---|
| [symbol] | Comparative Pre-LSP Data Set 1 |
| ••••••• | Comparative Pre-LSP Data Set 2 |
| [symbol] | Comparative Pre-LSP Data Set 3 |

All comparative data have been normalized to a percentile to Data No. 1 of Comparative Pre-LSP Data Set 1 (at 0.0000 mm depth) shown below in TABLE 4. FIG. 7 shows the (211) peak width distribution (B ½) values, also normalized to a percentile to Data No. 1 of Comparative Pre-LSP Data Set 1 shown below in TABLE 4. Normalized Data for Comparative Pre-LSP Data Sets 1, 2, and 3 used for graphs 60, 70 are below (see TABLES 4, 5, and 6).

TABLE 4
Comparative Data Set 1
Pre-LSP Surface - Normalized to Data No. 1

| Data | | | |
|---|---|---|---|
| No. | Depth (mm) | Residual Stress (normalized relaxation) | B ½ |
| 1* | 0.0000 | −100% | 100% |
| 2 | 0.0508 | −92% | 90% |
| 3 | 0.0991 | −76% | 80% |
| 4 | 0.1499 | −69% | 70% |
| 5 | 0.2007 | −55% | 62% |
| 6 | 0.2489 | −41% | 53% |
| 7 | 0.5055 | −3% | 44% |
| 8 | 0.7493 | −1% | 44% |
| 9 | 0.9982 | 1% | 43% |

*All data have been normalized to Data No. 1 of Comparative Data Set 1

TABLE 5
Comparative Data Set 2
Pre-LSP Surface - Normalized to Data No. 1
of Comparative Data Set 1

| Data | | Residual Stress | |
|---|---|---|---|
| No. | Depth (mm) | (normalized) | B ½ |
| 1 | 0.0000 | −115% | 96% |
| 2 | 0.0483 | −109% | 101% |
| 3 | 0.1016 | −95% | 90% |
| 4 | 0.1499 | −69% | 88% |
| 5 | 0.1981 | −56% | 70% |
| 6 | 0.2489 | −46% | 64% |
| 7 | 0.5004 | −9% | 43% |
| 8 | 0.7518 | 0% | 40% |
| 9 | 1.0008 | 3% | 40% |

TABLE 6
Comparative Data Set 3
Pre-LSP Surface - Normalized to Data No. 1
of Comparative Data Set 1

| Data | | | |
|---|---|---|---|
| No. | Depth (mm) | Residual Stress (normalized) | B ½ |
| 1 | 0.0000 | −144% | 110% |
| 2 | 0.0483 | −147% | 104% |
| 3 | 0.0991 | −139% | 113% |
| 4 | 0.1499 | −122% | 105% |
| 5 | 0.2007 | −117% | 101% |
| 6 | 0.2489 | −104% | 93% |
| 7 | 0.5004 | −18% | 47% |
| 8 | 0.7468 | 1% | 46% |
| 9 | 0.9957 | 3% | 46% |

Data Set 2 shows that LSP surface portion can achieve residual stress of −322%, which is a substantial improvement over the Pre-LSP surface portion at the surface (Data No. 1 of Comparative Pre-LSP Data Set 1). Accordingly, similar results could be achieved at various surface portions of the fuel pump head. For example, Post-LSP portions of fuel-side surface that includes at least one of the inlet check valve bore, the dome, the outlet check valve bore, and the outlet check valve seat would be able to withstand greater compressive stress. Thus, the fuel pump head 102 and the fuel pump 100 having LSP portion(s) would be able to withstand greater compressive stress. Thus, the fuel can be compressed by the fuel pump 100 at a higher compression ratio than fuel pumps without LSP portion(s). This can lead to higher operating fuel pressure and higher thermal efficiency of the fuel pump 100. Further, the fuel pump 100 and fuel pump head 102 can be formed without the need to add other materials. The higher operating pressures achieved by the fuel pump 100 and the fuel pump head 102 can increase engine fuel efficiency due to better cylinder-to-cylinder fuel distribution due to the more highly compressed fuel. Thus the fuel pump 100 and the fuel pump head 102 can consume less fuel for equivalent power output than conventional fuel pumps. The highly compressed fuel from the fuel pump 100 can achieve an increased fuel burn rate and can lead to a reduced output of emissions.

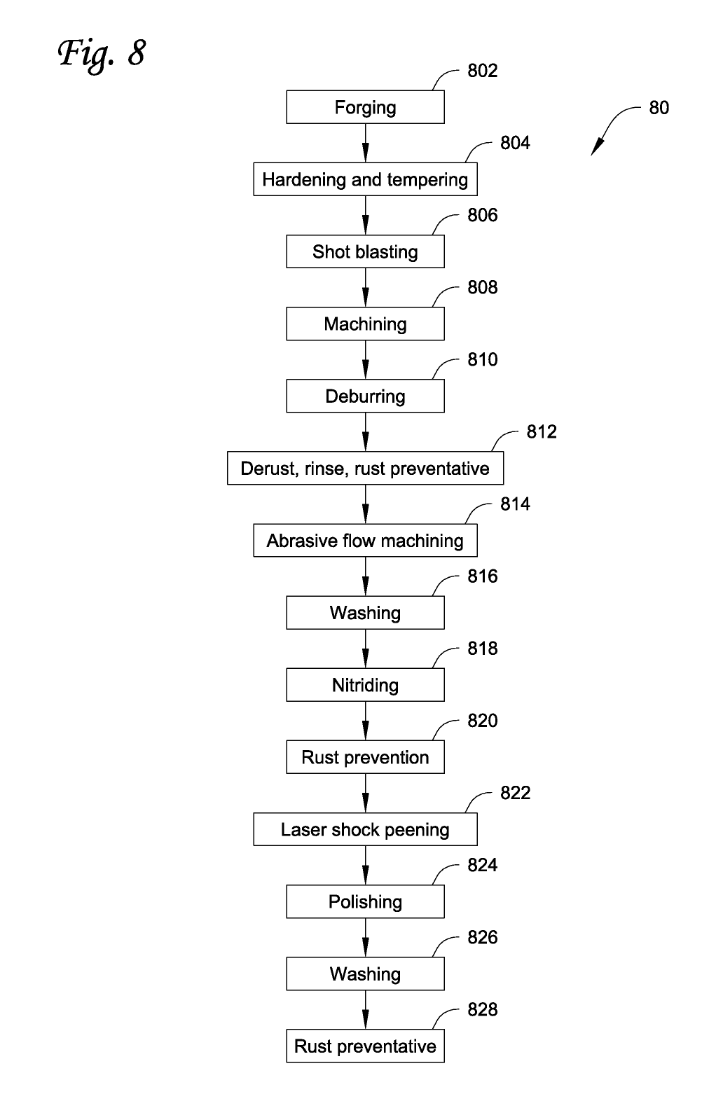

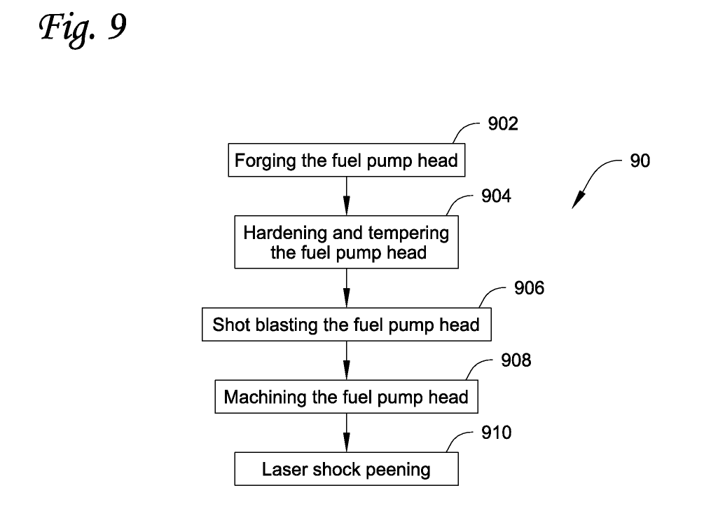

Another embodiment of a flow diagram for a method 80 for manufacturing the fuel pump head 102 is shown in FIG. 8. Prior to performing LSP to portion(s) of the fuel pump head 102, the fuel pump head 102 can be formed using conventional methods that can include forging 802, hardening and tempering 804, shot blasting 806, machining 808, and deburring 810 steps. The deburring 810 may include hand deburring, washing, and then thermal deburring. The process can also include derusting, rinsing, and rust prevention step 812, abrasive flow machining 814, and washing 816. Washing 816 may include crystal clean washing, alkaline washing, and acetone washing. Nitriding 818 is a surface hardening heat treatment process that involves diffusion of nitrogen in the surface of metal while still in the ferrite region to create a case hardened surface. Nitriding 818 provides high surface hardness, which increases wear resistance and improves fatigue life of a component being nitrided. Because nitriding 818 does not involve heating into the austenite phase and subsequent quenching to form martensite, it can provide minimum distortion and excellent dimensional control.

The method can include rust prevention 820 step and a polishing 824 step. FIG. 8 shows the polishing step 824 being performed after the laser shock peening 822 step. Alternatively, the polishing step 824 can be performed prior to the laser shock peening 822 step.

Laser shock peening 822 is performed at one or more of the surfaces 213, 215, 219, 221 inside the cavity of the fuel pump head 102. Then, the fuel pump head 102 can be washed 826, and another rust preventative 828 step is performed to the fuel pump head 102. Thus, the fuel pump head 102 can be obtained via the embodied method above.

Another embodiment of a flow diagram for a method 90 for manufacturing the fuel pump head 102 is shown in FIG. 9. The method 90 includes forging 902 the fuel pump head, hardening and tempering 904 the fuel pump head, shot blasting 906 the fuel pump head, machining 908 the fuel pump head, and laser shock peening 910 at least a portion of one or more of the fuel-side surface(s) 213, 215, 219, 221 of the fuel pump head 102, wherein the fuel pump head includes the inlet check valve bore 212, the inlet check valve bore being fluidly connected to the dome 214, the dome 214 being fluidly connected to the outlet check valve bore 218, and the outlet check valve bore 218 being fluidly connected to the outlet check valve seat 220.

A preferred embodiment has been described for illustrative purposes. Those skilled in the art will appreciate that various modifications and substitutions are possible without departing from the scope of the invention, including the full scope of equivalents thereof.

What is claimed is:

1. A fuel pump head for a fuel pump that transports fuel to a common rail of an automotive engine, the fuel pump head comprising:
a cavity for fuel flow,
the cavity having a fuel-side surface,
the fuel-side surface including a laser shock peened portion.

2. The fuel pump head for a fuel pump according to claim 1, wherein the cavity comprises:
an inlet check valve bore, the inlet check valve bore being fluidly connected to a dome;
the dome being fluidly connected to an outlet check valve bore; and
the outlet check valve bore fluidly connected to an outer check valve seat.

3. The fuel pump head according to claim 2, wherein the laser shock peened portion of the fuel-side surface includes at least one of the inlet check valve bore, the dome, the outlet check valve bore, and the outlet check valve seat.

4. A fuel pump for transporting fuel to a common rail of an automotive engine, the fuel pump comprising:
a cavity for fuel flow, the cavity including an inlet check valve bore, the inlet check valve bore being fluidly connected to a dome, the dome being fluidly connected to an outlet check valve bore, and the outlet check valve bore fluidly connected to an outer check valve seat,
wherein a fuel-side surface of the cavity includes a laser shock peened surface.

5. The fuel pump according to claim 4, wherein the laser shock peened surface includes at least one of the fuel-side surface of the inlet check valve bore, the fuel-side surface of the dome, the fuel-side surface of the outlet check valve bore, and the fuel-side surface of the outlet check valve seat.

6. A method for manufacturing a fuel pump head, comprising:
forging the fuel pump head;
hardening and tempering the fuel pump head;
shot blasting the fuel pump head;
machining the fuel pump head; and
laser shock peening a portion of a fuel-side surface of the fuel pump head, wherein the fuel pump head includes an inlet check valve bore, the inlet check valve bore being fluidly connected to a dome; the dome being fluidly connected to an outlet check valve bore; and the outlet check valve bore being fluidly connected to an outlet check valve seat.

7. The method according to claim 6, further comprising polishing the fuel pump head before the laser shock peening step.

8. The method according to claim 6, further comprising polishing the fuel pump head after the laser shock peening step.
